(19) United States
(12) Patent Application Publication
(10) Pub. No.: US 2008/0165717 A1
(43) Pub. Date: Jul. 10, 2008

(54) Novel MBMS user detection scheme for 3GPP LTE

(76) Inventors: Ning Chen, Austin, TX (US); Natarajan Ekambaram, Austin, TX (US); Jeffrey Keating, Austin, TX (US)

Correspondence Address: HAMILTON & TERRILE, LLP, P.O. BOX 203518, AUSTIN, TX, 78720, US

(21) Appl. No.: 11/619,833

(22) Filed: Jan. 4, 2007

(51) Int. Cl. H04H 20/71; H04J 3/26

(52) U.S. Cl. 370/312; 370/432

(57) ABSTRACT

An MBMS user detection system and methodology (300) is provided for advertising available MBMS services by multiplexing user feedback requests (303) using time, frequency and/or code diversity so that one or more MBMS service users can be detected in a single polling time interval. Available MBMS services are assembled into a user feedback request (302) and assigned unique multiplex signaling codes so that a code for a first MBMS service (302.1) is orthogonal to a code for a second MBMS service (302.k). In addition, a queuing model (610) is provided for analyzing and optimizing how services are advertised in the user feedback requests.

### BACKGROUND OF THE INVENTION

1. Field of the Invention

The present invention is directed in general to field of information processing. In one aspect, the present invention relates to a system and method for signal processing and control signaling for wireless communication systems.

2. Description of the Related Art

Wireless communication systems are increasingly used to distribute or “broadcast” audio and/or video signals (programs) to a number of recipients (“listeners” or “viewers”) that belong to a large group. An example of such a wireless system is the 3GPP LTE (Long Term Evolution) system depicted in FIG. 1, which schematically illustrates the architecture of an LTE wireless communication system 1. As depicted, content from the broadcast server 28 is distributed through an EPC 26 (Evolved Packet Core) which is connected to one or more access gateways (AGW) 22, 24 that control transceiver devices, 2, 4, 6, 8 which communicate with the end user devices 10-15. In the LTE architecture, the transceiver devices 2, 4, 6, 8 may be implemented with base transceiver stations (referred to as enhanced Node-B or eNB devices) which in turn are coupled to Radio Network Controllers or access gateway (AGW) devices 22, 24 which make up the UMTS radio access network (collectively referred to as the UMTS Terrestrial Radio Access Network (UTRAN)). Each transceiver device 2, 4, 6, 8 device includes transmit and receive circuitry that is used to communicate directly with any mobile end user(s) 10-15 located in each transceiver device's respective cell region. Thus, transceiver device 2 includes a cell region 3 having one or more sectors in which one or more mobile end users 13, 14 are located; transceiver device 4 includes a cell region 5 having one or more sectors in which one or more mobile end users 15 are located; transceiver device 6 includes a cell region 7 having one or more sectors in which one or more mobile end users 10, 11 are located; and transceiver device 8 includes a cell region 9 having one or more sectors in which one or more mobile end users 12 are located. With the LTE architecture, the eNBs 2, 4, 6, 8 are connected by means of an S1 interface to the EPC 26, where the S1 interface supports a many-to-many relation between AGWs 22, 24 and the eNBs 2, 4, 6, 8.

An example of a broadcasting service that can be offered via existing cellular networks, such as Global System for Mobile Communications (GSM) and Universal Mobile Telecommunications System (UMTS), is the Multimedia Broadcast Multicast Service (MBMS). The MBMS infrastructure provides an uplink channel for interaction between the broadcast service and the user, and also uses multicast distribution in the core network instead of point-to-point links for each end device, thereby allowing transmission resources in the core- and radio network to be shared. MBMS is in the process of being adopted in several current emerging standards, such as IEEE 802.16 and the 3rd Generation Partnership Project (3GPP) Long Term Evolution (LTE) platform. According to the recently released LTE specification for MBMS (3GPP TS 36.300 v0.2.0 (November 2006)), the MBMS infrastructure should permit simultaneous, tightly integrated and efficient provisioning of dedicated (unicast) and MBMS services to the user. In addition, the MBMS infrastructure should allow coordination of MBMS transmissions from several eNBs. And to avoid unnecessary MBMS transmission in a cell where there is no MBMS user, the MBMS network should be able to detect at least one MBMS user interested in the MBMS service in the cell, such as by using a polling technique. However, the LTE specification does not require counting of the precise number of user equipments (UEs) interested in an MBMS service, but instead leaves this option open for further study.

A proposed solution for detecting if there is an MBMS user in a cell who is interested in receiving the MBMS service in the cell is disclosed in IPWireless's proposal to 3GPP RAN2 meeting #54 in September 2006 entitled “Layer 1 Signalling Based User Detection for LTE MBMS,” IPWireless, R2-062271. In this proposal, a controller, such as an eNB, implements a “user detection” feature which uses time multiplexing to poll users in a cell for different signature sequences, each of which identify an MBMS service. In operation, the controller initiates the detection procedure by sending a UE feedback request message which includes the MBMS service ID (on which user feedback is required) and “dedicated access information” that is to be used for the user feedback by the UEs. After receiving the feedback request message, any UEs interested in receiving the particular MBMS service respond to the request by sending a feedback message using the allocated “dedicated access resources.” The “dedicated access information” takes the form of a particular signature sequence. Thus, the user feedback message is simply the transmission of the allocated dedicated signature sequence (i.e., the user feedback is implicitly delivered to the network within the signature sequence). All interested UEs send the allocated signature sequence on non-synchronous Random Access Channel (RACH) preamble burst. By having both idle and connected state UEs use non-synchronous RACH for the user feedback, this allows a common user detection procedure for both idle and connected state UEs. As a result, the reception of the signature sequence at the eNB indicates that at least one user in the coverage area of the eNB is interested or activated the particular MBMS service, but does not allow the number of users to be decided accurately.

FIG. 2 illustrates an example of how signature sequences in the IPWireless proposal may be time multiplexed between a number of MBMS services for purposes of detecting if any user needs an MBMS service broadcast in a given cell. At the first MBMS user feedback request instance (T1), a first user feedback request for MBMS Service X is issued. The user feedback request for MBMS Service Y is requested at a second MBMS user feedback instance (T2), user feedback request for MBMS Service Z is requested at a third MBMS feedback instance (T3), and so on. In this way, the user feedback instances are scheduled for different MBMS services by the network controller so that two MBMS services can not be requested at the same user feedback instance. The UEs respond to a user feedback request by sending the indicated signature sequence as part of the RACH preamble burst. To schedule the time multiplexed user feedback requests, the separation between user feedback request instances are designed to avoid the overlap of user feedback responses intended for different MBMS services. Thus, the gap between two consecutive user feedback request instances (e.g., between T1 and T2) should be large enough for all the UEs which are interested in the service (e.g., UE 21, UE 22 and UE 23) to respond to the first user feedback request. This is shown in FIG. 2, which depicts the gap between the first and second user feedback request instances as being larger than the largest data response time (DRX) of a UE in the cell.

Accordingly, there is a need for an improved MBMS service polling system and methodology for polling a plurality of MBMS services in a single time interval and/or with a single user feedback request instance. There is also a need for an MBMS user detection scheme that can be modeled, analyzed and adjusted to effectively detect at least one user in a cell that requires one or more MBMS services. In addition, there is a need for an improved system and methodology for detecting if there are users in a cell that are interested in obtaining one or more MBMS services which overcomes the problems in the art, such as outlined above. Further limitations and disadvantages of conventional solutions will become apparent to one of skill in the art after reviewing the remainder of the present application with reference to the drawings and detailed description which follow.

### BRIEF DESCRIPTION OF THE DRAWINGS

The present invention may be understood, and its numerous objects, features and advantages obtained, when the following detailed description of a preferred embodiment is considered in conjunction with the following drawings, in which:

FIG. 1 schematically illustrates the architecture of an LTE wireless communication system;

FIG. 2 illustrates an example of how signature sequences may be time multiplexed between a number of MBMS services;

FIG. 3 illustrates an example signal flow for a user feedback procedure for multiplexing user feedback requesting MBMS services;

FIG. 4 depicts an example MBMS service map which may be constructed and used at a controller to assign a specific combination of signature sequence, frequency band and/or time interval to each MBMS service;

FIG. 5 depicts a flow for an example MBMS polling procedure; and

FIG. 6 schematically illustrates a bulk service queuing model which may be used to analyze and adjust a multiplexed MBMS service detection scheme; and

FIG. 7 depicts simulation results comparing the performance benefits of multiplexing user feedback for a plurality of MBMS services.

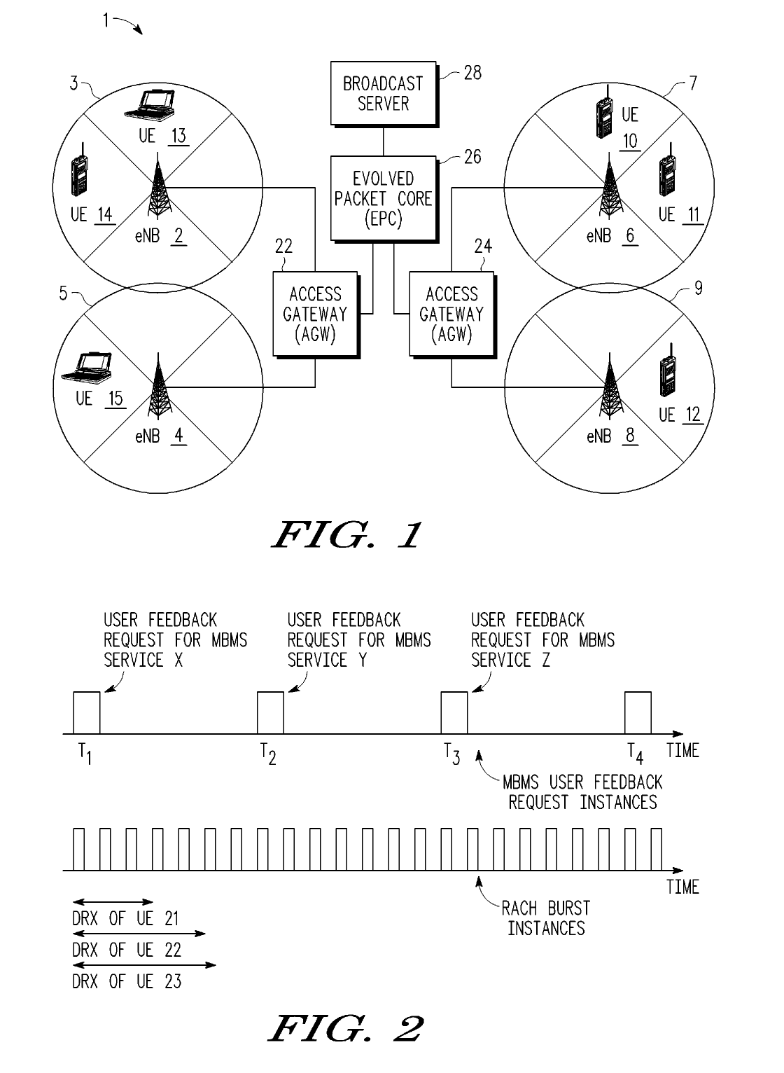

### DETAILED DESCRIPTION

A system and methodology are described for multiplexing user feedback requests using time, frequency and/or code diversity so that one or more MBMS service users can be detected in a single polling time interval. By using a two or three-dimensional coding scheme to identify MBMS services, the service waiting time and control information overhead can be reduced as compared to conventional time multiplexing solutions. In various example embodiments, a transceiver device (such as an eNB, controller or base station) advertises available services by broadcasting or sending a user feedback request which includes a list of one or more MBMS services and associated multiplex signaling codes for each listed MBMS service. Upon receiving the user feedback request, any user (such as a mobile user device or other user equipment) that wants to receive any of the listed MBMS services sends an MBMS service request in the form of a feedback response to the transceiver device which identifies the desired MBSM services to be broadcast. To allow multiplexing of more than one feedback response from any given user, the feedback response is sent using the multiplex signaling code associated with any desired MBMS service, where the multiplex signaling code specifies a predetermined frequency and/or code-based signaling scheme for the associated MBMS service. For example, frequency-based signaling information (such as OFDM or single-carrier FDMA signaling information) may be assigned to each MBMS service listed in the user feedback request to specify that the feedback response for a first MBMS service is to be sent using a first predetermined frequency, that a second predetermined frequency is to be used to provide a feedback response for a second MBMS service, and so on. In addition or in the alternative, code-based signaling information (such as CDMA Walsh codes, pseudo-random codes or other orthogonal code signaling information) may be assigned to each MBMS service listed in the user feedback request to specify that the feedback response for a first MBMS service is to be sent using a first predetermined CDMA code, that a second predetermined CDMA code is to be used to provide a feedback response for a second MBMS service, and so on. In selected embodiments, each MBMS service included in a user feedback request may be assigned unique and orthogonal time/frequency/code signaling information so that multiple MBMS service requests can be multiplexed in a single polling interval. For example, the signaling information assigned to first MBMS service may be separated from the signaling information assigned to other MBMS services by assigning at least a unique frequency band and/or a unique signature code to the first MBMS service, though in addition a unique time slot may also be assigned to the first MBMS service. To account for differing MBMS service advertisement rates over time, a bulk service queuing model is provided for use in optimizing the MBMS service polling process. For example, the process may be optimized by adjusting the maximum number of MBMS services included in a user feedback request and/or by adjusting the polling interval used to broadcast user feedback requests.

Various illustrative embodiments of the present invention will now be described in detail with reference to the accompanying figures. While various details are set forth in the following description, it will be appreciated that the present invention may be practiced without these specific details, and that numerous implementation-specific decisions may be made to the invention described herein to achieve the device designer's specific goals, such as compliance with process technology or design-related constraints, which will vary from one implementation to another. While such a development effort might be complex and time-consuming, it would nevertheless be a routine undertaking for those of ordinary skill in the art having the benefit of this disclosure. For example, selected aspects are shown in block diagram form, rather than in detail, in order to avoid limiting or obscuring the present invention. In addition, some portions of the detailed descriptions provided herein are presented in terms of algorithms or operations on data within a computer memory. Such descriptions and representations are used by those skilled in the art to describe and convey the substance of their work to others skilled in the art. Various illustrative embodiments of the present invention will now be described in detail below with reference to the figures.

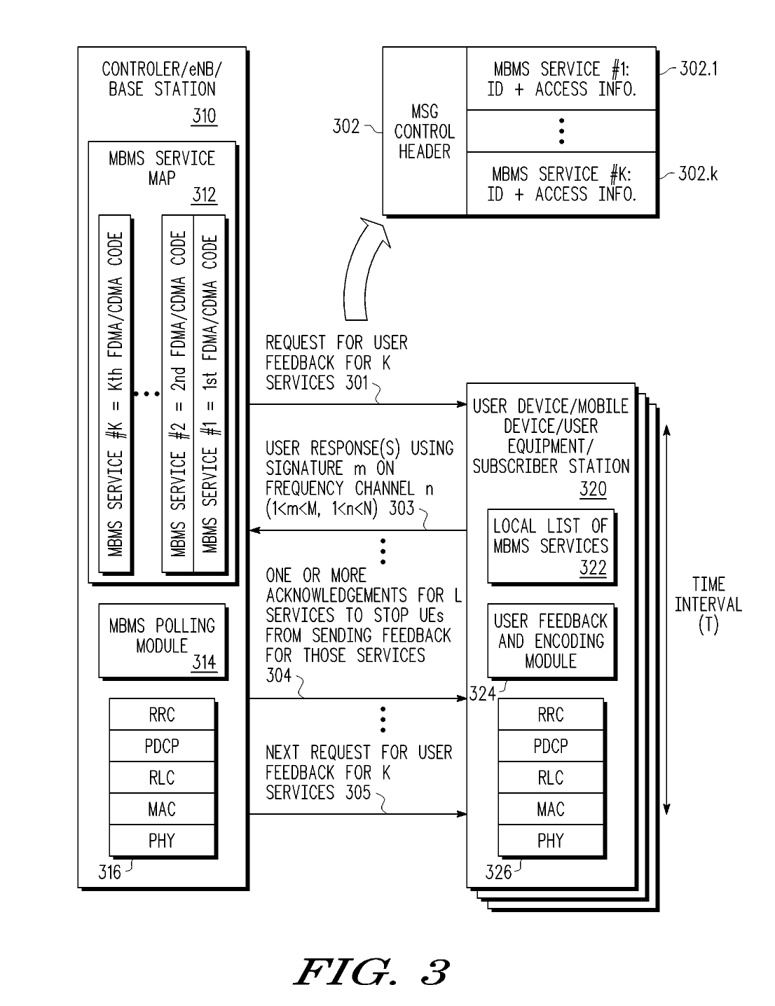

FIG. 3 illustrates an example signal flow for a user feedback procedure between a controller device 310 (such as an eNB, controller or base station) and a user device 320 (such as a mobile device, subscriber station or other user equipment) which exchange messages using protocol stacks 316, 326 at the controller and user device, respectively. On some predetermined basis (such as a polling interval), the controller 310 initiates a “user detection” process for determining if MBMS services are required in the broadcast region(s) associated with the controller 310. The controller 310 initiates the detection procedure by selecting a group of “K” MBMS services and then sending a user feedback request (indicated at 301) for user feedback for the selected “K” services. Any desired signaling scheme may be used for the user feedback request, though in an example implementation, the user feedback request 302 is provided as an L2 or L3 layer message that is controlled by the RLC, PDCP or RRC layers of the protocol stack 316. Likewise, the format of the user feedback request may also be configured as desired, though in an example embodiment, the user feedback request message 302 is formatted to include an appropriate message control header (to identify the user feedback request as such) and a list 302.1-k of one or more MBMS services on which user feedback is requested. In the depicted example, the user feedback request message 302 includes multiplex signaling information for each listed MBMS service. The multiplex signaling information defines the access information that is to be used by the user device 320 to send a feedback message identifying the particular MBMS service(s) to be broadcast to the user devices 320. For example, MBMS service #1 is identified with a service ID and associated access information at 302.1, where the access information defines multiplex signaling information (such as a first frequency and/or code-based signaling scheme) that may be used to control the feedback response from any user device 320 wishing to receive a broadcast of MBMS service #1. Any other MBMS services (e.g., MBMS service #K) are also identified with a corresponding service ID and associated access information (e.g., at 302.k) which defines different multiplex signaling information (such as a second frequency and/or code-based signaling scheme that is different from the first frequency and/or code-based signaling scheme). In this way, requests from the user device(s) 320 for different MBMS services can be multiplexed together in the same polling interval by designing the multiplex signaling information for one MBMS service so that it is different from the multiplex signaling information for another MBMS service.

To this end, an MBMS polling module 314 at the controller 310 implements a multiplexing scheme by constructing and assigning the multiplex signaling information to each MBMS service. In an example implementation, the MBMS polling module 314 uses code and/or frequency information to construct multiplex signaling information, though other multiplexing techniques may be used. However constructed, the multiplex signaling information may be stored at the controller 310 in a data structure, such as the MBMS service map 312 in which distinct FDMA/CDMA codes are assigned to each MBMS service. When the MBMS polling module selects one or more MBMS services to be included in a user feedback request (e.g., MBMS Service #1), the map 312 is accessed to retrieve the multiplex signaling information (e.g., 1st FDMA/CDMA Code) associated with the selected MBMS service(s), and the retrieved information is included as access information in the user feedback request 302.

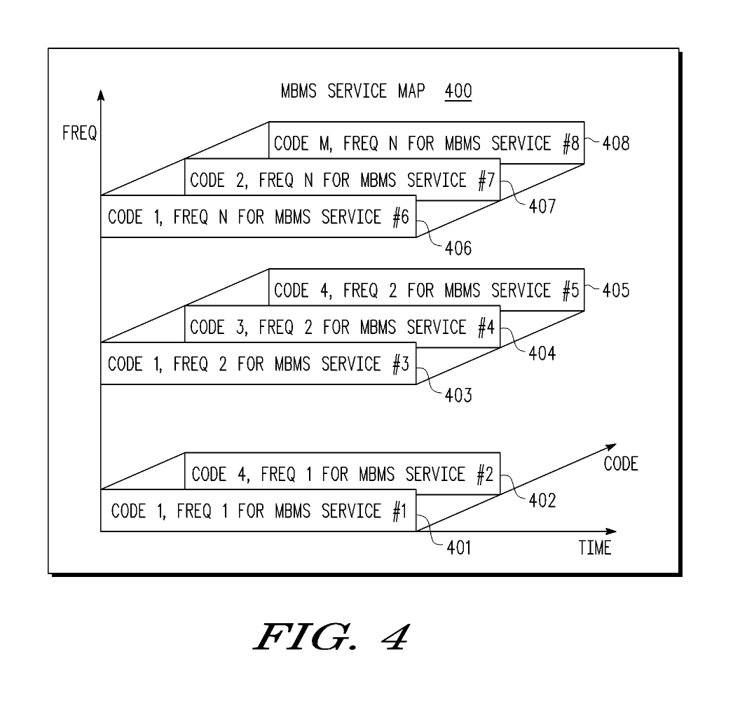

FIG. 4 illustrates how an MBMS service map 400 may be constructed and used at a controller to assign multiplex signaling information for each MBMS service. In the depicted MBMS service map 400, each of eight MBMS services (#1-#8) is assigned a unique combination of signature sequence, frequency band and/or time interval. In particular, the example MBMS service map 400 uses three dimensions (frequency, code and time) to assign a first code/frequency combination (Code 1, Frequency 1) to MBMS service #1 at map entry 401, and to assign a second code/frequency combination (Code 4, Frequency 1) to MBMS service #2 at map entry 402. In addition, a third code/frequency combination (Code 1, Frequency 2) is assigned to MBMS service #3 at map entry 403, a fourth code/frequency combination (Code 3, Frequency 2) is assigned to MBMS service #4 at map entry 404, and a fifth code/frequency combination (Code 4, Frequency 2) to MBMS service #5 at map entry 405. Finally, the map assigns a sixth code/frequency combination (Code 1, Frequency N) to MBMS service #6 at map entry 406, assigns a seventh code/frequency combination (Code 2, Frequency N) to MBMS service #7 at map entry 407, and assigns an eighth code/frequency combination (Code M, Frequency N) to MBMS service #8 at map entry 408. By constructing and maintaining the map 400 at the controller, user feedback request messages can be constructed in connection with an MBMS service polling mechanism, and in addition, any user feedback messages can be multiplexed and properly interpreted by the controller to identify which MBMS services are receiving feedbacks. For example, even though both MBMS service #1 and MBMS service #2 are assigned the same frequency (Frequency 1), they have the different code/frequency combinations by virtue of the different assigned codes (Code 1 vs. Code 4). As a result, a user feedback message requesting MBMS service #1 can be multiplexed in the same polling interval response with a user feedback message requesting MBMS service #2, and the messages can be properly interpreted at the controller by accessing the MBMS service map 400 to determine which MBMS service corresponds to which detected code/frequency combination. As suggested by the MBMS service map 400, it is possible to use only frequency assignments to differentiate between different MBMS services, as shown by the fact that MBMS Service #1, MBMS Service #3 and MBMS Service #6 are distinctly designated in the map on the basis of frequency only. Likewise, it is possible to use only CDMA-type coding assignments to differentiate between different MBMS services, as shown by the fact that MBMS Service #1 and MBMS Service #2 are distinctly designated in the map on the basis of code only. However, by using code/frequency combinations, more MBMS services can be readily and uniquely identified.

Referring back to the signal flow shown FIG. 3, once a user device 320 receives a user feedback request message 302, a user feedback and encoding module 324 or other selection module in the user device 320 compares the service IDs in the message 302 with its own interests, which may be stored at the user device in a local list of MBMS services 322. Where the user device 320 identifies one or more MBMS services from the message 302 that the user device 320 is interested in receiving (e.g., by finding a match with the local list 322), the user device 320 sends a feedback message 303 identifying the requested MBMS service. Depending on the type of multiplexing signaling information specified for the desired MBMS service, the user feedback and encoding module 324 uses the allocated multiplex signaling information for that MBMS service to request the identified MBMS service. Again, any desired signaling scheme may be used for the feedback message 303, though in an example embodiment, the feedback messages are sent using the signaling technique specified in the allocated multiplex signaling information (e.g., in a dedicated frequency band as preamble). In an example embodiment where the multiplex signaling information takes the form of a particular signature code “m” on a frequency channel “n,” the user feedback and encoding module 324 generates the user feedback message 303 requesting transmission of the service by simply transmitting a one-bit request message (e.g., “1”) using the allocated dedicated signature sequence “m” on the dedicated frequency “n” in a preamble sequence for non-synchronous RACH access. As a result, the user feedback is implicitly delivered to the network within the frequency-encoded signature sequence.

The controller 310 may be implemented in the form of a correlating receiver which receives the feedback message(s) 303 from the user device(s) 320 in the form of one or more code/frequency combinations, where each code/frequency combination uniquely identifies a requested MBMS service. When a code/frequency combination is received at the controller 310 that corresponds to an assigned MBMS service in the map 312, this indicates that at least one user in the coverage area of the controller 310 is interested in, or has otherwise activated, the assigned MBMS service. And when the code/frequency combinations are selected to be non-interfering, a plurality of MBMS service requests can be multiplexed and serviced together in the same polling time interval using a simple physical layer signaling protocol to detect the presence (or absence) of MBMS-activated users in a cell.

As will be appreciated, different user devices 320 may receive and process the user feedback requests at different times over the course of a given polling time interval T (as indicated by the ellipses below the feedback message 303). However, regardless of when or how many feedback messages 303 corresponding to a particular MBMS service are sent, all feedback messages corresponding to a particular MBMS service will use the same multiplex signaling information (e.g., code/frequency combination) to identify the requested MBMS service. To prevent the user device(s) from sending feedback messages 303 that have already been received and detected, the controller 310 may send an acknowledgement 304 when a request for a particular MBMS service has been detected. At the user devices 320, the acknowledgment 304 can be handled as an L1 signal to stop transmitting feedback messages corresponding to that particular MBMS service, thereby reducing signaling overhead for downlink transmissions. Additional signaling overhead may be conserved by sending a plurality of acknowledgements 304 (as indicated by the ellipses below the acknowledgement 304) using some predetermined scheduling mechanism (e.g., periodically or when some threshold event is reached), where each acknowledgement identifies the L services that have been detected since the last acknowledgement. In this way, the MBMS service requests that are detected first are acknowledged first, and subsequently detected MBMS service requests are acknowledged later in the polling interval.

In the polling process described above, the controller 310 issues a user feedback request 301 for “K” services over the course of a polling time interval T, where T is the maximum possible response time for any user device 320 in the cell. One or more user devices 320 send feedback messages 303 corresponding to one or more MBMS services, and in response, the controller 310 sends one or more acknowledgements 304 that L (where L is less than or equal to K) service requests have been detected, effectively instructing the user devices 320 to stop sending feedback for the L services. At the next polling interval, the controller 310 sends another user feedback request 305 which may include up to “K” selected MBMS services, and the similar procedure repeats.

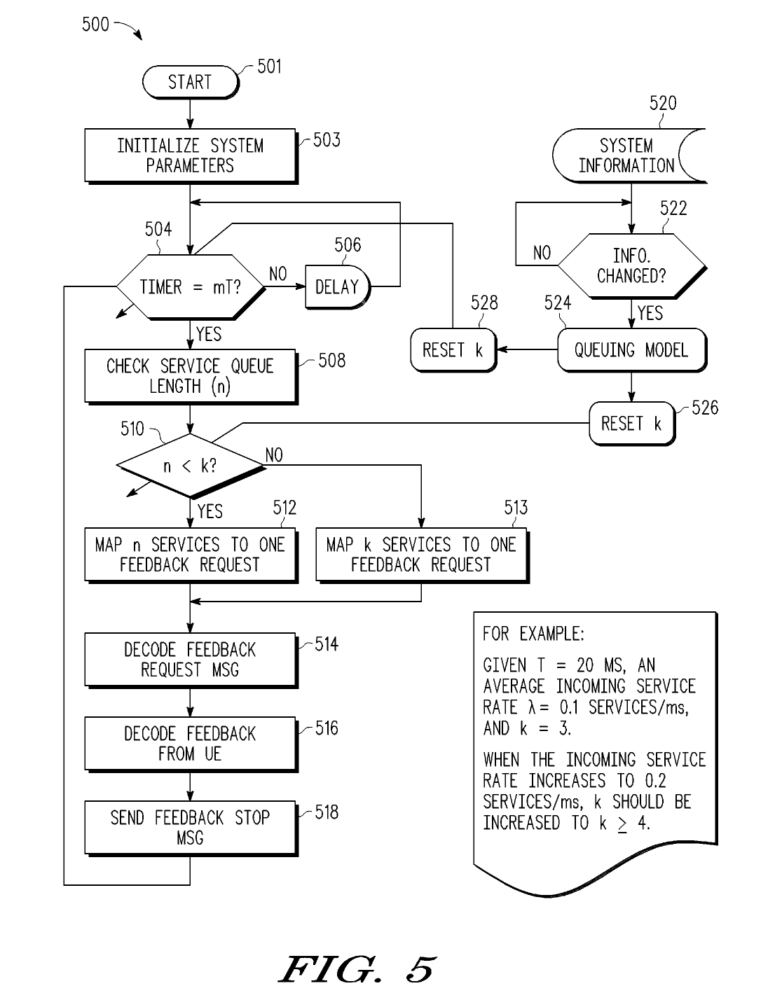

Selected embodiments of the present invention may also be illustrated with reference to FIG. 5, which depicts an flow 500 for an example MBMS polling procedure which may be used at a network controller (such as an eNB device or base station) to detect any user device in the controller's cell area that is requesting an MBMS service from the controller. As depicted, the process starts (step 501) when the controller initializes the system parameters (step 503), such as by defining the maximum number of services (K) that will be polled in a time interval (T), where T is defined to equal to or greater than the maximum possible response time for any user equipment in the controller's cell(s). In an example embodiment, K and T may be defined using the algorithm K>λT, where λ is the average rate for incoming services to the controller. In addition, K may be defined so that each of the K services can be uniquely identified by the available multiplex signaling information. In the case where the multiplex signaling information is formed from M codes and N frequencies, K may be defined using the algorithm K≦M×N. The result is that, on average, total number of services being polled in any given time interval should be less or equal to the degree of freedom provided by the multiplex signaling information.

Once the system is initialized, the next polling interval is detected at step 504, such as by checking a timer to see if an integer multiple “m” of the polling interval “T” has been reached. If not (negative outcome to decision block 504), the timer is re-checked after a delay (step 506). However, when a polling interval is reached (affirmative outcome to decision block 504), the controller checks the service queue, which contains or buffers the incoming service advertisement requests for the controller, to see how many service advertisement requests “n” are pending (step 508). In an example embodiment, a service advertisement request refers to an MBMS service which is available for broadcast by the controller if any user equipment requests the service. If the number of pending service advertisement requests “n” is less than or equal to the polling capacity “K” (affirmative outcome to decision block 510), then the controller maps the “n” services to a feedback request message (step 512). However, if the number of pending service advertisement requests “n” is greater than the polling capacity “K” (negative outcome to decision block 510), then the controller selects “K” of the “n” pending service advertisement requests and maps the selected “K” services to a feedback request message (step 513).

Once the service advertisement request mapping is complete, the controller sends the feedback request message (step 514) which includes a list of K service IDs and their corresponding code/frequency/time signaling information. Any user equipment that detects the feedback request message can compare the listed service IDs with its own interests, and if there are any matches, the user equipment sends a feedback message with the corresponding codes in dedicated frequency bands as preamble. Having received code/frequency/time signaling information in the feedback request message for each listed service, the user equipment uses this information to use code/frequency/time multiplexing when sending the feedback messages to the controller. Using the previously assembled map, the controller decodes the feedback messages received from any user equipment (step 516) to identify which of the listed services have been acknowledged by the UEs. When the code/frequency/time signaling information is designed to be non-interfering, the controller is able to distinctly detect feedback messages for different services in the same polling interval. At the end of the polling interval (or at different times over the course of the polling interval), the controller sends one or more “feedback stop” messages (step 518) to or acknowledge which service requests have been detected and to instruct the user equipment that feedback messages are no longer required for the detected service requests. Thus, the controller can send a plurality of “feedback stop” messages during any given polling interval T, where each feedback stop message lists the service request(s) detected since the last feedback stop message. The process repeats once the next polling interval is reached (as shown by the feedback line to step 504).

To allow for adjustments to the MBMS polling procedure when there are changes to the system information (such as changes in the rate of incoming service advertisement requests), the system information is assembled (step 520) and monitored for changes (detection block 522). When there is a change in the system information (affirmative outcome to decision block 522), the controller invokes a queuing model (step 524) to determine if the system parameters should be changed, such as by changing or resetting the polling capacity “K” (step 526) or the time interval T (step 528). For example, assume that the existing system information specifies a polling time interval T=20 ms, an average incoming service rate λ=0.1 services/ms, and a polling capacity K=3. If the incoming service rate increases to 0.2 services/ms, the queuing model 524 would be used to increase the polling capacity K to K≧4.

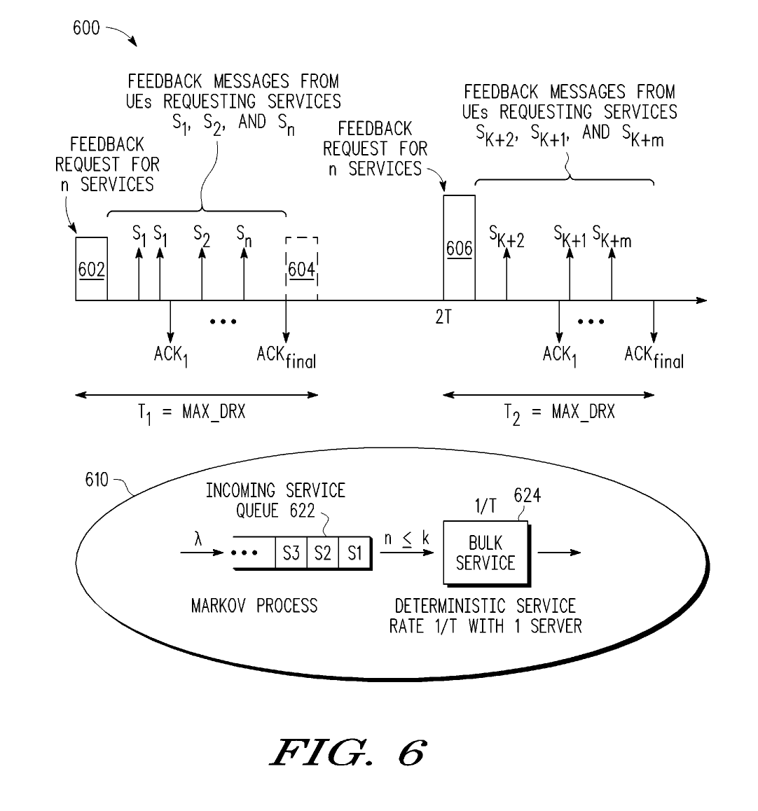

FIG. 6 schematically illustrates an example queuing model 610 which may be used to analyze and adjust a multiplexed MBMS service detection scheme. The model uses a Markov process to characterize the polling procedure with an average incoming service rate λ. Any pending service advertisement requests (e.g., S1, S2, S3, etc) are stored in a queue 622 until such time as they are processed by the bulk service 624 to advertise their availability to user equipment devices in a user feedback request message. Where the bulk service 624 is implemented as a single server that can include only K services in any user feedback request message for a given polling interval T, the value of K should be determined to be K>λT. The result is a bulk service queuing model that processes only n≦K of the pending service advertisement requests in a given polling interval T, thereby providing a deterministic service rate of 1/T.

An example of how a bulk service queuing model may be used to adjust a multiplexed MBMS service detection scheme is illustrated in FIG. 6 with the signal timing diagram 600. For a first polling interval T₁, a user feedback request 602 is broadcast which requests feedback on “n” services listed in the request 602. The length of the first polling interval T₁ is set to be equal to, or longer than, the maximum data response time (MAX_DRX) from any user equipment in the area. The “n” services are selected from the incoming service queue where they have been arriving at an average incoming service rate of λ services/millisecond, and are processed together provided that they do not exceed the polling capacity K of the bulk service 624. In response to the user feedback request 602, feedback messages for some of the listed services (S₁, S₂, and Sₙ) are received at the controller over the course of the polling interval T₁. By using the multiplex signaling information assigned to each service in the user feedback request, feedback messages for multiple services can be received and demultiplexed to detect service requests from any user equipment in the controller's cell area(s). In addition, acknowledge messages may be broadcast by the controller as the feedback messages are received, or at least at the end of the polling interval T₁, to indicate which service requests have been detected already. For example, an acknowledgment signal ACK₁ is sent which identifies the services (e.g., S₁) detected thus far.

In the event there is a change in the system information, the bulk service queuing model adjusts the system parameters to effectively change the service rate at the next polling interval T₂. For example, if the user equipment response time changes for a given controller, adjustments could be made to the minimum length of the polling interval T₂, to the number of code/frequency combinations or to the service queue length. In another example, if there is an increase in the average incoming service rate λ, the bulk service queuing model can reduce the length of the polling interval T₂ to effectively increase the rate at which services are advertised. This is shown in the signal timing diagram 600 where a shorter polling interval T₂ is used for the second user feedback request 606 which requests feedback on “m” services listed in the request 606. However, the length of the second polling interval T₂ should be at least as long as the maximum data response time (MAX_DRX) from any user equipment in the area to allow feedback messages (e.g., S_{K+2}, S_{K+1}, and S_{K+M}) from all user equipment to be received at the controller over the course of the polling interval T₂. As depicted in the signal timing diagram, the polling interval can be reduced so that the next user feedback request 604 is sent immediately upon the conclusion of the first polling interval T₁, though the polling intervals may also be spaced apart so that the second polling interval T₂ occurs well after the first polling interval T₁. Alternatively, the bulk service queuing model can increase the polling capacity K by modifying the multiplex signaling information so that “m>n” services can be processed together, provided that they do not exceed the increase polling capacity K.

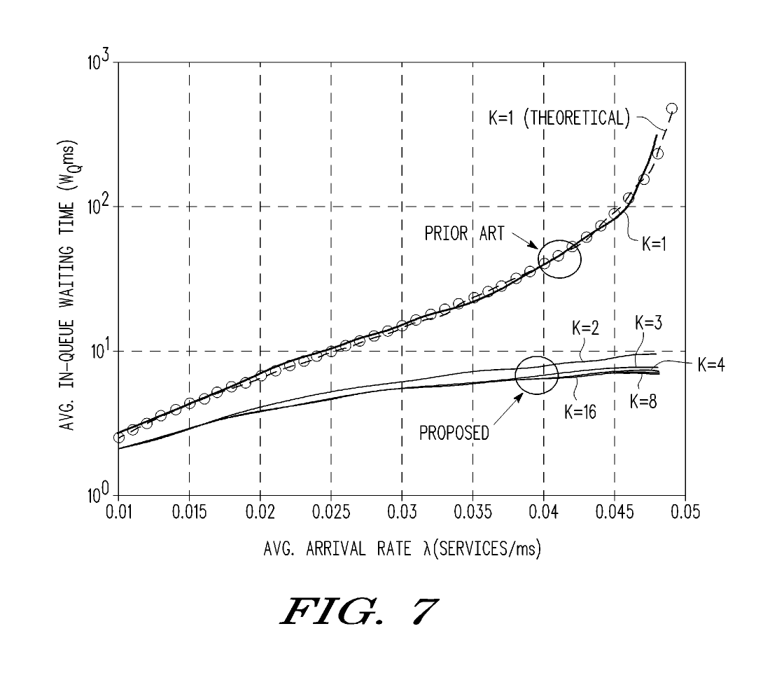

By multiplexing two or more service requests in a given polling interval, the average in-queue waiting time for service advertisement requests may be significantly reduced, as compared to conventional approaches (such as described in the IPWireless proposal) where only a single service request in each polling interval. As shown in the simulation results for different empirically measured values of the single interval polling capacity K depicted in FIG. 7, this performance benefit increases as the average arrival rate λ of service advertisement requests increases. In particular, the average time that a service is waiting in the queue for being processed (W_{Q}) is lower when service requests for two or more services are multiplexed in a polling interval, even as the average rate of incoming services (λ in # of services per ms) increases. While the average in-queue waiting time does not significantly increase as the polling capacity increases above 2 or 3, the larger polling capacity values mean that a higher average rate of incoming services can be serviced by the system. In addition, where K is the number of distinct service request responses that may be detected in a given interval, the estimated control overhead is reduced by (K−1)/K %.

By now it should be appreciated that there has been provided a method and system for detecting a plurality of multiplexed MBMS service requests in a single polling interval. At a controller (such as an enhanced Node-B device, base station or network controller), a user feedback request message is sent or broadcast in a first polling interval, where the user feedback request message lists a plurality of available MBMS services and a corresponding plurality of multiplex signaling codes such that a unique multiplex signaling code is assigned to each available MBMS service. The controller also detects user feedback messages in the first polling interval, where each user feedback message requests an MBMS service and is sent by a user device (such as a user equipment device, subscriber station or mobile device) using a multiplex signaling code assigned to the requested MBMS service in the user feedback request message. The multiplex signaling codes can be designed to include first access signaling information defined by a first frequency/code combination, and second access signaling information defined by a second frequency/code combination) that is orthogonal to the first frequency/code combination. The multiplex signaling codes can also be designed to include a first access signaling information (defined by a first combination of signature sequence, frequency band and/or time interval) and a second access signaling information (defined by a second combination of signature sequence, frequency band and/or time interval), such that the first access signaling information is orthogonal to the second access signaling information. On some predetermined schedule or when service requests are detected, the controller may send one or more acknowledgment messages identifying one or more MBMS services (if any) that have been requested in previously detected user feedback messages. With this methodology and system, a queuing model may be used to adjust how many available MBMS services are included in the user feedback request message in response to changes in an average incoming service rate parameter. In addition or in the alternative, the queuing model may be used to adjust the first polling interval in response to changes in an average incoming service rate parameter.

In another form, there is disclosed a method and system for multiplexing a plurality of MBMS service requests. As described, a user device (such as a receiver, user equipment device, subscriber station or other mobile device) receives a user feedback request message that is sent by a controller (such as an enhanced Node-B device, base station or network controller) in a first polling interval. As received, the user feedback request message includes a plurality of available MBMS services and a corresponding plurality of multiplex signaling codes such that a unique multiplex signaling code is assigned to each available MBMS service. The multiplex signaling codes can be designed to include a first access signaling information defined by a first frequency/code combination, and a second access signaling information defined by a second frequency/code combination) that is orthogonal to the first frequency/code combination. The multiplex signaling codes can also be designed to include a first access signaling information (defined by one or both of a first signature sequence and a first frequency band) and a second access signaling information (defined by one or both of a second signature sequence and a second frequency band), such that the first access signaling information is orthogonal to the second access signaling information. After selecting one or more of the available MBMS services to be one or more requested MBMS services, the user device then sends one or more user feedback messages in the first polling interval. Each user feedback message identifies a requested MBMS service and is sent using a multiplex signaling code assigned to the requested MBMS service in the user feedback request message. On some predetermined basis, the user device receives one or more acknowledgment messages, where an acknowledgment message identifies one or more MBMS services that have been requested in previously detected user feedback messages. The acknowledgment message allows a user device to stop sending user feedback messages that request the MBMS services identified in the acknowledgment message(s).

In still yet another form, there is provided a communication device and methodology for multiplexing user feedback requests using frequency and code diversity signals. The disclosed communication device may include a selection module for selecting one or more available MBMS services from a user feedback request message received in a first polling interval, where the user feedback request message identifies a plurality of available MBMS services, each of which has an assigned multiplex signaling code constructed from a unique combination of code sequence and frequency band so that the multiplex signaling codes are orthogonal to one another. For example, in a selected embodiment, a first multiplex signaling code assigned to a first MBMS service is a first code sequence on a first frequency band, and a second multiplex signaling code assigned to a second MBMS service is a second code sequence on a second frequency band, where the first code sequence and first frequency band are orthogonal to the second code sequence and the second frequency band. The communication device also includes a user feedback and encoding module for sending one or more user feedback messages in the first polling interval, where each of the one or more user feedback messages requests an MBMS service and is encoded using the assigned multiplex signaling code for the requested MBMS service. For example, in a selected embodiment where a first multiplex signaling code assigned to a first MBMS service is a first code sequence on a first frequency band, the user feedback and encoding module generates a user feedback message requesting the first MBMS service by transmitting a one-bit request message using the first code sequence on the first frequency band in a preamble sequence for non-synchronous RACH access. In addition, the user feedback and encoding module may be configured to receive one or more acknowledgment messages, where an acknowledgment message identifies one or more MBMS services that have been requested in previously detected user feedback messages. Upon receipt of such an acknowledgement message, the user feedback and encoding module may be configured to stop sending user feedback messages requesting any MBMS services identified in the acknowledgement message.

The methods and systems for adjustably multiplexing the feedback of service requests from users as shown and described herein may be implemented in software stored on a computer-readable medium and executed as a computer program on a general purpose or special purpose computer to perform certain tasks. For a hardware implementation, the elements used to perform various signal processing steps at the controller (e.g., generating service maps, advertising available services in user feedback requests, adjusting system parameters, and so on) and/or at the user equipment (e.g., receiving user feedback requests, providing feedback messages to request services, and so on) may be implemented within one or more application specific integrated circuits (ASICs), digital signal processors (DSPs), digital signal processing devices (DSPDs), programmable logic devices (PLDs), field programmable gate arrays (FPGAs), processors, controllers, micro-controllers, microprocessors, other electronic units designed to perform the functions described herein, or a combination thereof. In addition or in the alternative, a software implementation may be used, whereby some or all of the signal processing steps at each of the controller and user equipment may be implemented with modules (e.g., procedures, functions, and so on) that perform the functions described herein. It will be appreciated that the separation of functionality into modules is for illustrative purposes, and alternative embodiments may merge the functionality of multiple software modules into a single module or may impose an alternate decomposition of functionality of modules. In any software implementation, the software code may be executed by a processor or controller, with the code and any underlying or processed data being stored in any machine-readable or computer-readable storage medium, such as an on-board or external memory unit.

Although the described exemplary embodiments disclosed herein are directed to various systems and methods for multiplexing user feedback messages, the present invention is not necessarily limited to the example embodiments illustrate herein. For example, various embodiments of the feedback multiplexing system and design methodology disclosed herein may be implemented in connection with various proprietary or wireless communication standards, such as IEEE 802.16e, 3GPP-LTE, DVB and other multi-user MIMO systems. Thus, the particular embodiments disclosed above are illustrative only and should not be taken as limitations upon the present invention, as the invention may be modified and practiced in different but equivalent manners apparent to those skilled in the art having the benefit of the teachings herein. Accordingly, the foregoing description is not intended to limit the invention to the particular form set forth, but on the contrary, is intended to cover such alternatives, modifications and equivalents as may be included within the spirit and scope of the invention as defined by the appended claims so that those skilled in the art should understand that they can make various changes, substitutions and alterations without departing from the spirit and scope of the invention in its broadest form.

Benefits, other advantages, and solutions to problems have been described above with regard to specific embodiments. However, the benefits, advantages, solutions to problems, and any element(s) that may cause any benefit, advantage, or solution to occur or become more pronounced are not to be construed as a critical, required, or essential feature or element of any or all the claims. As used herein, the terms “comprises,” “comprising,” or any other variation thereof, are intended to cover a non-exclusive inclusion, such that a process, method, article, or apparatus that comprises a list of elements does not include only those elements but may include other elements not expressly listed or inherent to such process, method, article, or apparatus.

What is claimed is:

1. A method for detecting a plurality of Multimedia Broadcast Multicast Service (MBMS) service requests, comprising:
sending a user feedback request message in a first polling interval, where the user feedback request message comprises a plurality of available MBMS services and a corresponding plurality of multiplex signaling codes such that a unique multiplex signaling code is assigned to each available MBMS service; and
detecting a plurality of user feedback messages in the first polling interval, where each of the plurality of user feedback messages requests an MBMS service and is sent using a multiplex signaling code assigned to the requested MBMS service in the user feedback request message.

2. The method of claim 1, where the plurality of multiplex signaling codes comprises:
first access signaling information defined by a first frequency/code combination; and
second access signaling information defined by a second frequency/code combination that is orthogonal to the first frequency/code combination.

3. The method of claim 1, where the plurality of multiplex signaling codes comprises:
first access signaling information defined by one or both of a first signature sequence and a first frequency band; and
second access signaling information defined by one or both of a second signature sequence and a second frequency band, such that the first access signaling information is orthogonal to the second access signaling information.

4. The method of claim 1, further comprising sending one or more acknowledgment messages, where an acknowledgment message identifies one or more MBMS services that have been requested in previously detected user feedback messages.

5. The method of claim 1, where the user feedback request message is sent by a controller, such as an enhanced Node-B device, base station or network controller.

6. The method of claim 1, where the plurality of user feedback messages are sent by one or more user devices, such as a user equipment device, subscriber station or mobile device.

7. The method of claim 1, further comprising using a queuing model to adjust how many available MBMS services are included in the user feedback request message in response to changes in an average incoming service rate parameter.

8. The method of claim 1, further comprising using a queuing model to adjust the first polling interval in response to changes in an average incoming service rate parameter.

9. A method for multiplexing a plurality of Multimedia Broadcast Multicast Service (MBMS) service requests, comprising:
receiving a user feedback request message in a first polling interval, where the user feedback request message comprises a plurality of available MBMS services and a corresponding plurality of multiplex signaling codes such that a unique multiplex signaling code is assigned to each available MBMS service;
selecting one or more of the plurality of available MBMS services to be one or more requested MBMS services; and
sending one or more user feedback messages in the first polling interval, where each user feedback message identifies a requested MBMS service and is sent using a multiplex signaling code assigned to the requested MBMS service in the user feedback request message.

10. The method of claim 9, where the plurality of multiplex signaling codes comprises:
first access signaling information defined by a first frequency/code combination; and
second access signaling information defined by a second frequency/code combination that is orthogonal to the first frequency/code combination.

11. The method of claim 9, where the plurality of multiplex signaling codes comprises:
first access signaling information defined by one or both of a first signature sequence and a first frequency band; and
second access signaling information defined by one or both of a second signature sequence and a second frequency band, such that the first access signaling information is orthogonal to the second access signaling information.

12. The method of claim 9, further comprising receiving one or more acknowledgment messages, where an acknowledgment message identifies one or more MBMS services that have been requested in previously detected user feedback messages.

13. The method of claim 9, where the user feedback request message is sent by a controller, such as an enhanced Node-B device, base station or network controller.

14. The method of claim 9, where the one or more user feedback messages are sent by one or more user devices, such as a user equipment device, subscriber station or mobile device.

15. A communication device for multiplexing user feedback requests using frequency and code diversity signals, comprising:
a selection module for selecting one or more of a plurality of available Multimedia Broadcast Multicast Service (MBMS) services from a user feedback request message received in a first polling interval, where the user feedback request message comprises a plurality of available MBMS services, each of which has an assigned multiplex signaling code constructed from a unique combination of code sequence and frequency band so that the multiplex signaling codes are orthogonal to one another; and
a user feedback and encoding module for sending one or more user feedback messages in the first polling interval, where each of the one or more user feedback messages requests an MBMS service and is encoded using the assigned multiplex signaling code for the requested MBMS service.

16. The communication device of claim 15, where a first multiplex signaling code assigned to a first MBMS service comprises a first code sequence on a first frequency band, and where a second multiplex signaling code assigned to a second MBMS service comprises a second code sequence on a second frequency band, where the first code sequence and first frequency band are orthogonal to the second code sequence and the second frequency band.

17. The communication device of claim 15, where a first multiplex signaling code assigned to a first MBMS service comprises a first code sequence on a first frequency band.

18. The communication device of claim 17, where the user feedback and encoding module generates a user feedback message requesting the first MBMS service by transmitting a one-bit request message using the first code sequence on the first frequency band in a preamble sequence for non-synchronous Random Access Channel (RACH) access.

19. The communication device of claim 15, where the user feedback and encoding module is configured to receive one or more acknowledgment messages, where an acknowledgment message identifies one or more MBMS services that have been requested in previously detected user feedback messages.

20. The communication device of claim 19, where the user feedback and encoding module is configured to stop sending user feedback messages requesting any MBMS services identified in the acknowledgement message.
